(19) United States
(12) Patent Application Publication
(10) Pub. No.: US 2007/0137786 A1
(43) Pub. Date: Jun. 21, 2007

(54) Nanotube elongation

(76) Inventor: David E. Luzzi, Wallingford, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/009,930

(22) Filed: Dec. 10, 2004

Related U.S. Application Data
(60) Provisional application No. 60/601,784, filed on Aug. 16, 2004.
(60) Provisional application No. 60/528,948, filed on Dec. 11, 2003.

(51) Int. Cl. B32B 37/00

(52) U.S. Cl. 156/304.1; 156/272.8; 264/479; 264/485; 264/488

(57) ABSTRACT

Methods of joining nanotubes by applying sufficient radiation to induce non-deleterious joining of nanotubes. Also disclosed are method of treating nanotube fibers by applying radiation to nanotubes having structural defects and the like sufficient to foster nucleation and growth of a new nanotube.

### CROSS REFERENCE TO RELATED APPLICATIONS

This applications claims priority to U.S. Provisional application 60/601,784, filed Aug. 16, 2004, and U.S. Provisional application 60/528,948, filed Dec. 11, 2003, which the contents of both are incorporated herein by reference in their entirety.

### FIELD OF INVENTION

The invention relates to methods of conjoining the ends of carbon nanotubes in a non-deleterious manner. Also disclosed are methods of butt welding nanotubes and filing gaps between nanotube fibers.

### BACKGROUND OF INVENTION

Carbon nanotubes have been a focus of the research community due to their novel electrical transport and their structural and mechanical properties. As a class of nanomaterials, carbon nanotubes have shown a broad spectrum of useful properties that useful in device applications ranging from high strength fibers to the components for transistor logic gate circuits and including a host of commercial devices and system. Recent developments towards the production of single nanotube dispersions and the separation of metallic and semiconducting tubes give rise to applications based on isolated individual nanotubes.

Carbon nanotubes are also a unique class of materials whose structure can be modified in a controllable way by electron beam induced structural transformations. This is possible due to the nanotubes' structure based on a rolled graphene sheet, wherein curvature dictates the atomic displacement events in a unique way. When electron beam irradiation is carried out in the presence of thermal annealing, interesting structural morphologies, such as crossed junctions, have been produced. Under thermal annealing in the presence of an electron beam, neighboring individual nanotubes in a bundle can undergo coalescence yielding nanotubes of larger diameter. Moreover, the ability of carbon bonds to regenerate under vacuum at high temperature imparts on them the ability to recover their properties.

Recent progress in the production of dispersed nanotubes and spun fibers of pure nanotubes has raised the possibility of pure nanotube cables and wires. With the expected drop in the cost of nanotubes, this may lead to the replacement of existing cable technology for mechanical, electrical, and thermal management applications.

One of the elements of a nanotube-based cable technology is a means to connect nanotubes together within the fibers that make up the hierarchical structure of the cable. Butt welding is an example of such a means where the fibers have nanotubes that have ends that are in close (van der Waals) contact with each other or are connected through one or more covalent C—C bonds or through an intermediary group. For nanotubes that are spaced by some distance within the fiber, a means to fill this gap with new nanotubes is needed.

Many butt welding techniques are harmful to the nanotube side walls. In electron beam welding, the reaction and coalescence of C₆₀ molecules into tubes can be produced via electron irradiation at 100 and 200 keV energies. Above 100 keV, significant damage to the surrounding nanotube occurs via the ballistic displacement of carbon atoms from the side-walls of the nanotube can be seen. This is an undesired effect that renders this method undesireable.

Nanotubes may be the strongest materials ever made but they come in short lengths. These hybrid materials will have an increased amount of utilities if there were efficient means of growing nanotubes in long contiguous forms. Seeding catalyst nanoparticles have been used to sprout nanotubes but this method is still not satisfactory. Functionalization by organic chemistry has also been used to grow nanotubes. However, this method attacks the nanotube sidewalls and changes the hybridization of the sidewalls to that of a diamond. This weakens the sidewalls and any resulting system of nanotubes will have its strength rest not in the nanotube but in the linking molecule. Understandably, other properties of the nanotubes are lossed by this method, namely the electrical conductivity. Functionalization by organic chemistry is a glue used to link the nanotubes. There is a need for a method of linking nanotubes that preserves the innate strength of the nanotubes being joined.

Another method is to connect the nanotubes that are abutting each other but not bonded. The problem thus far rests with connecting the nanotubes without affecting the other segments of the tube, namely the sidewalls. Preserving the structure and strength of the sidewalls is imperative. The nanotube end caps have 5-member rings of carbon whereas the length of the tube is usually composed of 6-member rings. There is a need for a method of reacting only the end caps of nanotubes to join multiple nanotubes together while preserving the structure and stability provided by the nanotube sidewalls.

### SUMMARY OF INVENTION

A method of elongating carbon nanotubes in a carbon nanotube system comprising applying radiation at about 80 keV to about 90 keV to the nanotube system to react the end caps of abutting nanotubes without inducing structural deterioration of the nanotube sidewall. There are also methods of butt welding at least two carbon nanotubes in a carbon nanotube system wherein at least one nanotube comprises at least one C₆₀ molecule confined within the lumen of said nanotube, said method comprising applying radiation at about 80 keV to about 90 keV to the nanotube system to react the end caps of abutting nanotubes without inducing structural deterioration of the nanotube sidewall. In some methods that may be preferred, 86 keV may be used.

The present invention may also be described as being methods of elongating carbon nanotubes comprising irradiating a collection of carbon nanotubes with an energy between about 80 keV and about 90 keV for a time sufficient to react the end caps of a substantial proportion of abutting nanotubes without inducing structural deterioration of a substantial proportion of the sidewalls of the nanotubes.

### BRIEF DESCRIPTION OF THE DRAWINGS

FIG. 1 depicts TEM images of a SWNT on Si₃N₄/Si substrate subjected to electron beam irradiation at 100 kV for various electron beam doses. a) depicts an image of the starting nanotube showing the pristine surface of a SWNT. b) depicts the nanotube image after beam irradiation at dose of 1.6×10²⁶ electrons/m² showing the defective regions due to loss of atoms from the cylindrical graphene network. c) depicts the nanotube showing beam irradiation induced positive (see arrow) and negative curvature regions (see double arrows) after beam irradiation at dose of 2.04×10²⁶ electrons/m². d) depicts a nanotube showing the shrinkage in diameter after irradiation at a total beam dose of 4.08×10 electrons/m², illustrating the dimensional change.

FIG. 2 depicts TEM micrographs of a SWNT with a-C coating subjected to electron beam irradiation at 100 kV. a) depicts a micrograph of the nanotube showing the a-C coverage throughout its surface. b) depicts the nanotube after the beam irradiation showing the defective regions (see arrows). c) depicts a nanotube having structure disintegration after beam irradiation at a beam dose of 2.52×10²⁵ electrons/m².

FIG. 3 depicts TEM micrographs of a DWNT showing structure transformation when subjected to electron beam irradiation at 100 kV. a) is a micrograph of the nanotube (diameter ˜4 nm) showing two distinct regions. One region shows the a-C coverage (see left arrow) and the other with minimal a-C coverage (see right arrow). b) is a micrograph of a nanotube after beam irradiation dose of 3.7×10²⁶ electrons/m² showing structure degradation at the defective region (see left arrow), accompanied by re-arrangement of a-C on the surface of nanotube along with radial deformation along its length. c) depicts a nanotube showing structure disintegration (see left arrow) and diameter shrinkage (˜2.6 nm) on the right side after irradiation at beam dose of 5.04×10²⁶ electrons/m².

FIG. 4 depicts a TEM micrograph (on the left) showing a crossed junction of DWNTs undergoing structure transformation when subjected to electron beam irradiation at 100 kV. The set of micrographs on the right side illustrate the nanotube regions before and after the electron beam irradiation at total beam dose of ˜10.4×10²⁶ electrons/m². The a-C coating on the exterior of nanotube regions undergoes transformation into ordered graphitic structures which can be evidenced as additional graphene sheets in the high resolution images on the right side (see boxes).

FIG. 5 depicts TEM micrographs of peapods showing coalescence of fullerene molecules inside the SWNTs. a)-b) show micrographs of a peapod structure after irradiation with electron beam at 80 keV shows the coalescence of molecules and c)-e) show micrographs of a peapod undergoes the overall structure degradation due to irradiation by electron beam at energy 100 keV which is higher than the threshold energy for ballistic damage for nanotubes.

FIG. 6 is a clockwise sequence showing electron irradiation induced coalescence of C₆₀ molecules at 80 keV.

FIG. 7 depicts coalescence of C₆₀ molecules within the nanotubes of a bundle under 80 keV electron irradiation. No damage of nanotubes, or reaction of nanotube side-walls within the bundle is seen.

FIG. 8 depicts the formation of new graphene from carbonaceous impurities on nanotubes under 100 keV electron irradiation.

FIG. 9 depicts nucleation and growth of new nanotubes from carbonaceous impurities from thermal annealing in the presence of metallic particles

### DETAILED DESCRIPTION OF PREFERRED EMBODIMENTS

A nanotube is composed of two distinct features, a long tubular section composed of one or more nested side-walls and an end cap. Alternatively, a nanotube may be open in which case there is no end cap. To form a butt weld, the challenge is to induce the formation of covalent bonds between the ends of two or more nanotubes. In the case of a fiber which comprises many nanotubes, a fraction, perhaps a high fraction, of the nanotubes will abut end-to-end.

To help achieve these ends, the present invention discloses methods of elongating carbon nanotubes comprising applying radiation sufficient to induce a reaction between the end caps of abutting nanotubes without inducing a reaction, or harmful effect, on the nanotubes sidewalls. There are also methods of butt welding at least two carbon nanotubes wherein at least one nanotube comprises at least one C₆₀ molecule confined within the lumen of said nanotube, wherein radiation sufficient to induce joining of the nanotube ends without a deleterious effect on the nanotube sidewalls. Another embodiment is a method of elongating carbon nanotubes comprising irradiating a collection of carbon nanotubes with an energy between about 80 keV and about 90 keV for a time sufficient to react the end caps of a substantial proportion of abutting nanotubes without inducing structural deterioration of a substantial proportion of the sidewalls of the nanotubes.

The kinetic energy provided to the molecules and the subsequent close approach of adjacent molecules in a collision fosters covalent bond formation. The continued reaction and formation of a section of tube may then be assisted by high temperatures. Embodiments of the present invention may be conducted at temperatures between about 800° C. to about 1600° C. Other embodiments have a range of between about 100° C. to about 1300° C.

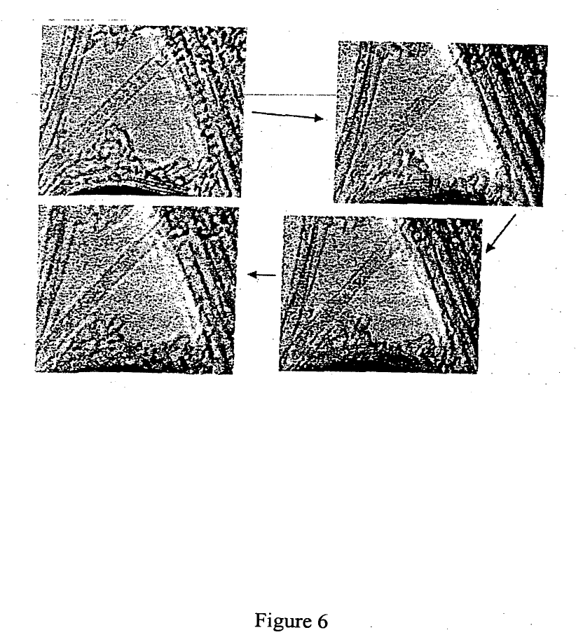

The present invention provides methods in which nanotubes are not damaged by electrons at some electron energies below 90 keV. Therefore, there are methods of filling gaps between nanotubes in fibers of nanotubes comprising irradiating nanotubes comprising graphene layers on the surface of said nanotubes between about 80 keV to about 90 keV sufficient to cause the nucleation and growth of a new nanotube. In some embodiments, the methods have an energy of about 86 keV to induce end cap reaction and ensure no damage to nanotube sidewalls (FIG. 6). At the suggested energies, ballistic damage of the nanotube side-wall will be minimized or not occur. Therefore, non-deleterious butt welding of opposing ends of nanotubes may be provided without damaging the side-walls of a nanotube.

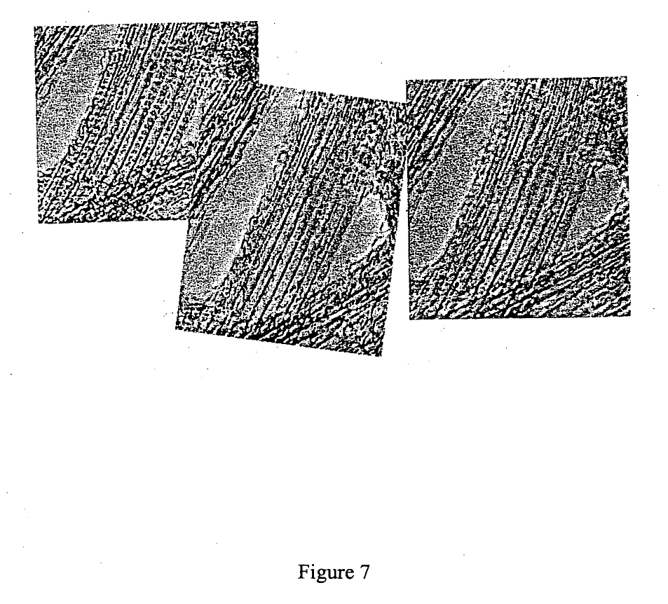

The physical chemistry of this is likely arising from one or more of a couple of features. The structure of the ends of nanotubes (and C₆₀ molecules) is composed of a mixture of five and six member rings of carbon. These are known to be more reactive and it is has been shown that it may be easier to accomplish chemical functionalization of the end of a nanotube versus the side. An additional effect is due to the curvature of the carbon shell. This curvature induces an outward bias of the p electron orbitals as shown in FIG. 6. For the case of opposing surfaces, the overlap of these orbitals will produce a higher reactivity. This will not be case for nested surfaces; thus the C₆₀ molecules do not react with the surrounding nanotube. However, the 80 keV reaction of the system in a nanotube rope in which opposing nanotube side-walls are present has been investigated. The results may be seen in FIG. 7. In this case, the reaction between the C₆₀occurs in the absence of side-wall/side-wall welding indicating the importance of the five-member rings.

The current of electrons necessary to induce welding in some embodiments of the present invention is less than 10²² electrons/cm² (nano-Amp range). A survey of electron beam welding systems used regularly in industry shows that the energy ranges of these commercial systems (50-150 keV) and current capability (mA) means that existing commercial systems may be used for in-line high velocity spinning manufacturing of nanotube fiber.

Useful in many embodiments of the present invention are single wall carbon nanotubes (SWNTs), double wall carbon nanotubes (DWNTs), and nanotube junctions. In some embodiments of the present invention, filled nanotubes having C₆₀ molecules confined in one-dimension inside the lumen of the nanotubes, or peapods, are used.

In some methods of the present invention, the end cap of a first carbon nanotube abuts an end cap of the second carbon nanotube. While in other embodiments, that may be preferred, the end cap of a first carbon nanotube abuts an open end of the second carbon nanotube.

The response of the nanotubes to an electron beam may be influenced by the presence of coatings of amorphous carbon, graphene fragments, and structural defects on the tube surface. The dependence of structural modifications on electron beam irradiation dose is also disclosed. While nanotubes with amorphous carbon, graphene fragment coverage, and/or defects undergo rapid transformation leading to structure disintegration, those without such coverage or defects are more resistant to beam damage. In addition, the amorphous carbon coverage on the double wall nanotubes may be transformed into graphene layers during electron beam irradiation of coated nanotubes. Finally, the relative stability of nanotube side-wall and end-walls were investigated through sub-threshold energy and above threshold energy irradiation of a model system, C₆₀-filled nanotubes (Peapods™). Electron beams may be used according to embodiments of the present invention to join nanotubes end-to-end without damaging the side-walls.

Diameter shrinkage may occur and may require a change in chirality in the individual nanotubes comprising the DWNT. If the chirality is modified, this may open new ways to tune the intrinsic electrical properties of nanotubes, which in turn may have important implications for device applications.

Embodiments of the present invention may have interesting ramifications for the structural modification of coated carbon nanotubes by controlled electron beam irradiation. For example, electron beam irradiation may be utilized to treat nanotube-containing materials such as nanotube fibers and composites to improve their mechanical properties. As mechanical properties degrade as a function of structural defects and a-C coverage on the nanotube surface, electron beam irradiation, possibly in combination with thermal annealing, may be utilized to transform the disordered carbon structures into ordered structures. Also, there may be a relationship between electron beam induced structural transformations and thermal annealing during the course of irradiation. As the beam induces defects and damage, in situ thermal annealing can heal the defects and counter the damage propagated by the electron beam. Also an irradiated single wall nanotube, being a defective structure, is presumed to have non-hexagonal carbon rings which render an entirely different density of states spectrum to the nanotubes.

Some embodiments of the present invention may utilize well isolated nanotube structures on the Si₃N₄/Si substrates, which can be studied by means of multiple processing schemes, such as beam irradiation, vacuum annealing, etc. The calculated electron beam dose based on measurements of the electron beam current density provides a means to quantitatively studying the structural transformations. It will be appreciated that the presence of a coating of amorphous-like carbon (a-C), graphene fragments and/or intrinsic defects in the nanotube wall strongly influence the sensitivity of the nanotubes to the electron beam and the transformation behavior. Peapods being hierarchical materials made by filling fullerene C₆₀ molecules inside SWNTs, have attracted the attention of the research community due to their tunable electronic properties. The present invention discloses electron beam induced structure transformation of peapods at acceleration voltages below the threshold for ballistic damage of the nanotubes.

Therefore, herein one will find methods of treating nanotube fibers comprising nanotubes having structural defects, an amorphous carbon coverage, or graphene layers on said nanotube surface, said method comprising irradiating the fibers below about 90 keV to cause the nucleation and growth of another nanotube. There are also methods comprising a first irradiation step comprising irradiating double wall nanotubes comprising amorphous carbon coverage on the walls of said nanotubes to form graphene layers lying commensurate with said nanotube and a second irradiation step comprising irradiating said nanotube having said graphene layers below 90 keV to cause the growth of another nanotube. As used herein, commensurate means of the same size, extent, or duration as another.

Electron beam radiation may be used in the embodiments of the present invention as the radiation used to treat nanotube fibers or to induce non-deleterious joining of the end cap with the second nanotube. The radiation may be applied within the range of about 80 keV to about 90 keV, or about 86 keV in many preferred embodiments.

It will be appreciated that other means of butt welding may be used with sufficient development. For instance, UV light can induce polymerization of C₆₀ molecules. There is dimerization by UV exposure, one may not detect tubule formation (i.e. full butt welding). It is possible that high intensity, or long exposure to UV light may promote butt welding. Alternatively, the use of UV light combined with thermal annealing may lead to the formation of a good nanotube butt weld. X-ray or other ionization radiations may also be used. In some embodiments radiant light may be used.

Lasers may be a means to provide high intensity light with specific frequency and may promote nanotube butt welding. Similarly. microwaves may provide excitation of the nanotubes as well as heating.

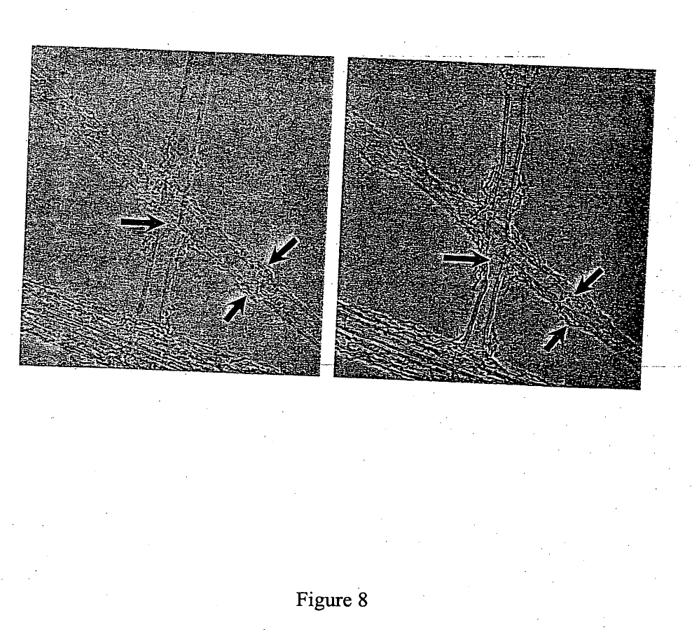

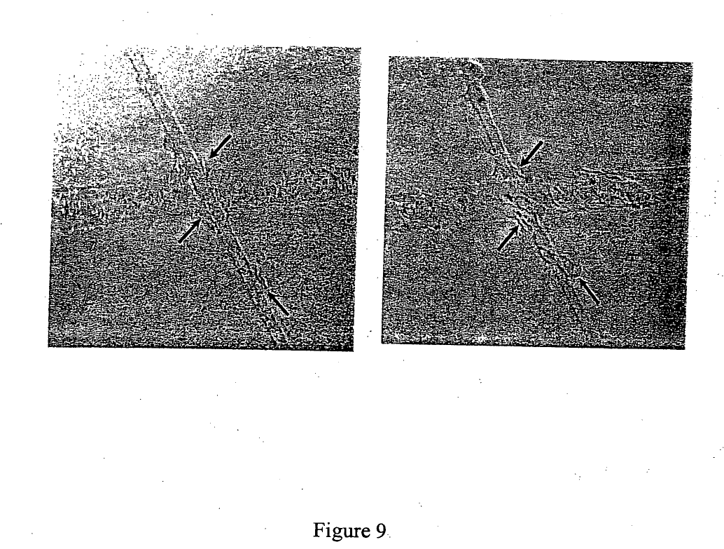

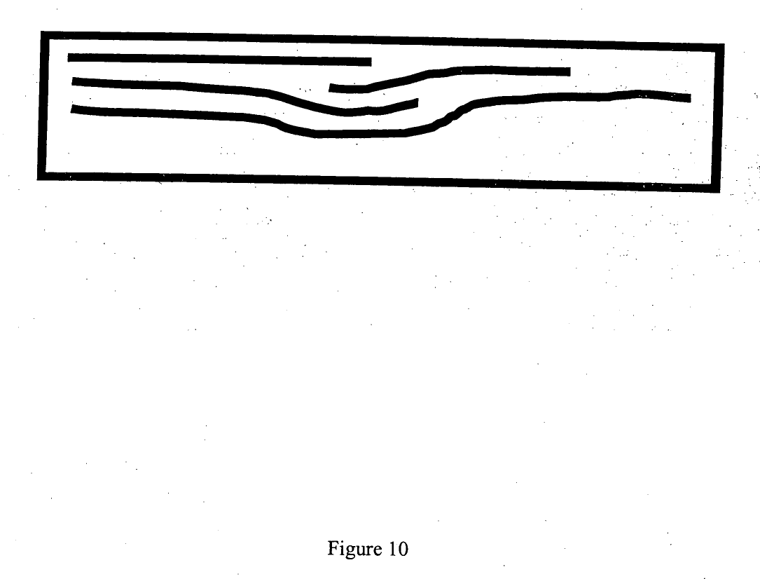

Nanotubes grown on silicon nitride substrates have been used as a model system to study progressive reactions in nanotube systems. FIG. 8 shows the formation under 100 keV electron irradiation of extra graphene layers growing on the surface of a nanotube. This graphene is forming from carbonaceous impurities that previously were coating these nanotubes. FIG. 9 shows that thermal annealing of carbonaceous impurities in the presence of small metal clusters leads to the nucleation and growth of new nanotube. Both of these techniques may lead to the production of new nanotube to fill gaps between nanotubes in fibers.

The FIG. 10 shows arrangements of nanotubes that may hinder the formation of butt welds within a spun fiber. It has been shown that these fibers can shrink by as much as 15% in length during annealing. This indicates that the nanotubes are mobile and are moving to fill voids as discussed above. A thermomechanical technique used in some embodiments may involve a process akin to strain aging used in the metals industries. A tensile stress may be applied on the fiber to slide nanotubes past each other to statistically allow the elimination of the dislocations shown in the figure. Then the stress may be released and an anneal will allow the nanotubes to slide together providing a microstructure more conducive to butt welding.

Various structure transformations in single and double wall carbon nanotubes brought about by electron beam irradiation in a transmission electron microscope were studied. The nanotubes undergo diameter shrinkage under the electron beam and thus show a reduction in dimensions. The presence of amorphous carbon and graphene fragment coatings and defects on the nanotube surface greatly influence the structure transformations in various nanotube structures under the electron beam. A SWNT under beam irradiation undergoes structure disintegration through shrinkage in diameter, while a DWNT maintains the cylindrical structure. Under electron beam irradiation the a-C and graphene fragment coverage on DWNT has been found to transform constructively to give rise to ordered structures comprising graphene layers lying commensurate with the nanotube wall. The crossed junction made of DWNTs with a-C coverage on the surface exhibits the nucleation of new graphene layers on the exterior, following beam irradiation. Electron irradiation of peapods composed of C₆₀ molecules within the nanotube lumen at energies below threshold exhibit an overall constructive structure transformation, wherein the fullerene molecules coalesce to give rise to co-axial tubes, leaving the surrounding nanotube unaffected. All of these transformations may have important implications for applications wherein the nanotubes structure can be controlled in a constructive fashion, to improve the mechanical, electrical and thermal properties of nanotube based fiber materials. Thus, electron beam irradiation may be utilized in a unique way to effect constructive structure transformations in nanotubes and peapods.

### EXAMPLES

### Example 1

The carbon nanotubes in the present work were synthesized by a chemical vapor deposition based approach using Si₃N₄/Si substrates. Briefly, single wall and double wall carbon nanotubes (SWNTs and DWNTs) were grown on windowed Si₃N₄/Si substrates using Fe as a catalyst and methane and/or ethylene as feedstock gases at 850° C.-950° C. The present CVD process yields well isolated and individual SWNTs, DWNTs, and crossed junctions of nanotubes, ideal for a study of the response of nanotubes to an electron beam. Electron beam irradiation studies were carried out in a 2010 F field emission transmission electron microscope (FE-TEM) at an acceleration voltage of 100 kV, with a column vacuum of ˜3×10⁻⁵ Pa. A given nanotube structure was irradiated under the beam at a constant beam dose rate and the images were recorded as a function of time. Sample substrates with dimensions in the range of 2 mm×2 mm-4 mm×4 mm and thickness of 0.5 mm, were loaded into a specially designed specimen cartridge for TEM in-situ studies. The electron beam current density incident on the specimen was determined from screen current measurements calibrated with a Faraday Cup. The electron beam dose on the specimen was calculated from this data using the calibrated magnifications and time measurements of irradiation exposure. Peapods were synthesized by vapor-phase filling of C₆₀ fullerene molecules in SWNTs produced by pulsed laser vaporization. The peapods were irradiated with an electron beam at acceleration voltages of 80 keV and 100 keV to induce the coalescence of fullerene molecules as well as the structural modification of the SWNTs encapsulating the fullerene molecules.

### Example 2

Electron Beam Irradiation of SWNTs

The structural modification of a clean SWNT under electron beam irradiation is dictated by the acceleration voltage of the electron beam. A threshold acceleration voltage ca. ˜86 keV was calculated for the SWNTs, beyond which atomic displacements lead to structure disintegration. These calculations were confirmed by empirical measurements which found no ballistic radiation damage at electron beam energy of −80 keV. However, presence of acid treated carbon nanotubes as well as structural defects greatly influence the structural stability of nanotubes under an electron-beam.

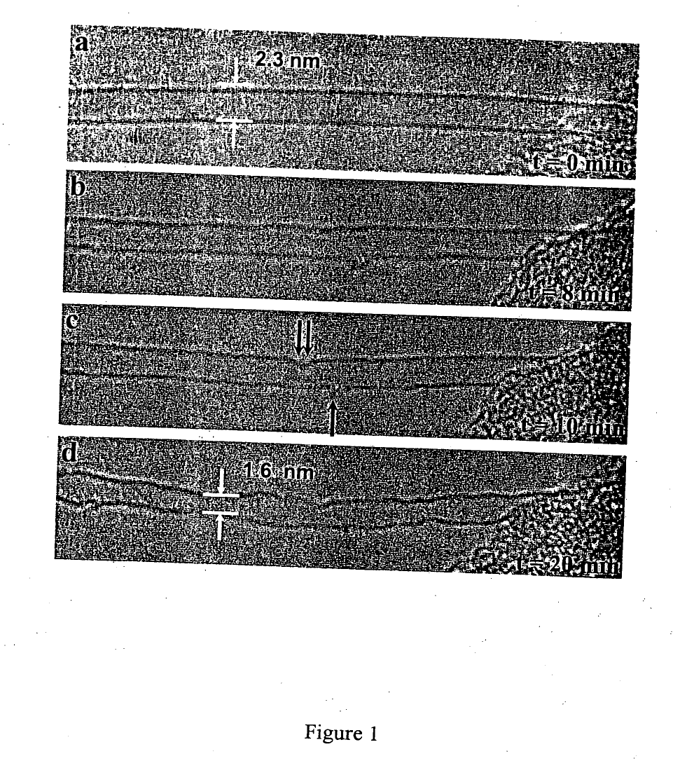

Carbon nanotubes grown by the CVD process are often partially covered with a coating and may contain defects in the nanotube wall. It has been shown and calculated that these factors can affect the electrical transport properties of the nanotubes. The response of a clean 2.3 nm diameter SWNT to 100 keV electron beam irradiation at a dose rate of ˜3.4×10²³ electrons/m²·sec is shown in FIG. 1(a)-(d). The HRTEM image in FIG. 1A shows the SWNT as a pair of dark lines encompassing the hollow interior, which is the projection of the cylindrical graphene structure onto the imaging plane. It is known that 100 keV electrons are only capable of displacing the carbon atoms from the portions of the cylindrical graphene structure whose surface normal is parallel or nearly parallel to the electron beam (ie. the top and bottom surfaces). During irradiation, once local structural defects have formed under the beam, further atom loss events accelerate the distortion of the nanotube cylindrical structure. These carbon atom loss events result in the distortion of the cylindrical graphene lattice seen in projection in the HRTEM images. This can be evidenced by the appearance of positive (see bottom arrow) and negative curvature (see top double arrows) in the graphene nanotube wall (FIG. 1(c)). With further beam irradiation, a general apparent reduction of the nanotube diameter is observed, more so locally at the defective regions. The average apparent diameter of the nanotube shrinks from 2.3 nm to 1.6 nm during the course of beam irradiation. In the final stage of observation, the graphene cylindrical structure becomes rippled, which is arguably due to the loss of registry between the portions of structure not experiencing atom displacements (side-walls). This may be caused by the loss of integrity of heavily displaced portions (top and bottom walls), further leading to the total collapse of the tubular structure (see FIG. 1(d)). From the measured dose rate and the duration of irradiation, the electron-beam dose for this structure disintegration is ˜4.08×10²⁶ electrons/m². This beam dose is comparable with doses reported in literature, wherein a marginally higher beam dose was observed for the case of a SWNT synthesized by the laser method. At higher doses than that of FIG. 1d, the nanotube structure was observed to break. This process typically involves the loss of one of the side walls, followed shortly after by complete breakage. Imaging is prevented by severe vibration of the nanotube structure in these final stages.

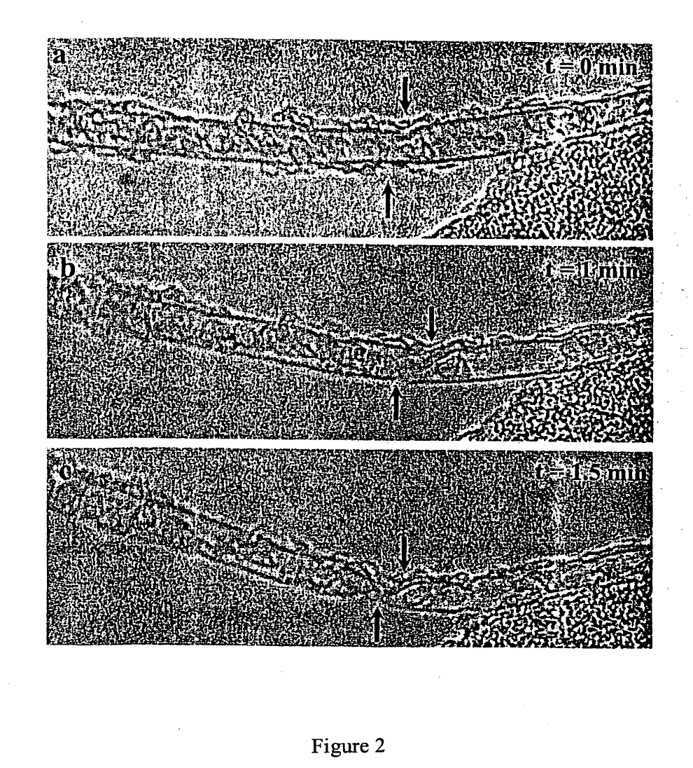

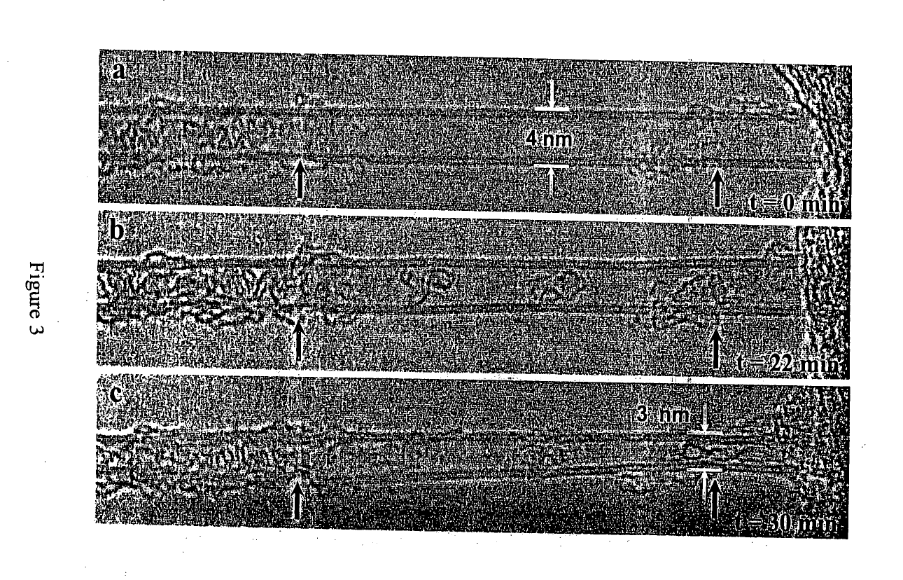

An uncoated SWNT exhibits apparent diameter shrinkage followed by structure disintegration under electron beam irradiation (FIG. 1). The response of a coated 3.1 nm diameter SWNT to 100 keV electrons, at a dose rate of ˜2.8×10²³ electrons/m²·sec is shown in FIG. 2a-c. As illustrated in the series of micrographs (FIG. 2(a)-(c)), the presence of a coating and/or defects influences the response of the nanotube such that the structure disintegration is rapid. At an electron beam dose of ˜1.7×10 electrons/m², the nanotube develops local defects in its structure, as seen in FIG. 2(b) (see arrows). This dose value for inducing structural defects in a coated nanotube is an order of magnitude lower than that for a nanotube (FIG. 1(b)) without such coverage (˜1.6×10²⁶ electrons/m). Once the first structural defects are introduced by the beam irradiation, the structure disintegration accelerates, leading to a local collapse of the cylindrical graphene structure at these sites (see arrows in FIG. 2C). Thus, the coating and defects on the surface of the nanotube render it more susceptible to beam irradiation damage. The data suggests that the presence of various defects in the SWNT can greatly reduce its resistance to beam damage. This is consistent with published work that has shown that the presence of a-C and structural defects in carbon nanotubes can increase their susceptibility to various processing treatments such as air oxidation, acid reflux etc. The measured electron beam dose for the complete local disruption of the cylindrical structure of a coated SWNT is ˜2.5×10²⁵ electrons/cm², which is lower by over an order of magnitude than the dose required for the earlier case as in FIG. 1.

### Example 3

Electron Beam Irradiation of DWNTs

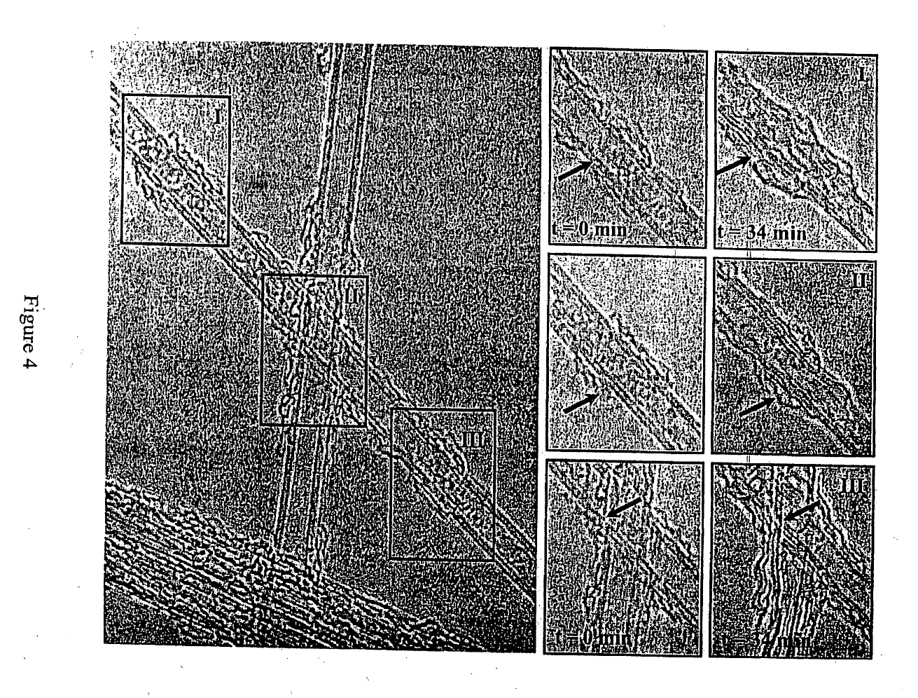

A double wall nanotube, by definition comprises two concentric graphene cylinders nested one inside the other. This nanostructure is entirely different from an isolated cylinder represented by a SWNT, thus making it interesting to study, including its response to electron beam irradiation. In FIG. 3(a), a DWNT can be seen that has two regions of interest, one with minimal exterior coating (see arrow on the right) and the other with extensive coating (see arrow on the left). The micrographs in FIG. 3(a)-(c) show the evolution of the structure of a DWNT of diameter 4 nm under 100 keV electron irradiation at a dose rate of 2.8×10² electrons/m²·sec. The DWNT is much more resilient to electron beam irradiation than a SWNT, especially with regard to the disruption of the cylindrical structure. In FIG. 3(c), the DWNT remains largely intact at the left side of the figure, despite a total dose which is 20 times that of the SWNT of FIG. 2(c). At the right side of the figure, it is observed that for a DWNT, the nanotube structure free of coating shows a constructive reorganization, wherein the tube diameter shrinks by 35% (FIG. 3(a) to 3(c)), without the collapse of the cylindrical structure. This is in contrast to the response of a SWNT, wherein, there is an eventual breakdown of the cylindrical structure as seen in FIG. 1(d). The presence of the inner tube appears to prevent the outer tube from collapsing during irradiation, even though both tubes shrink in size due to atom displacement events. In this scenario one may not rule out some kind of cooperative atom exchange between the two graphene cylinders. The nanotubes maintain the characteristic van der Waal's spacing between the nested tubes throughout the entire process of diameter shrinkage, in spite of the disorder induced by the beam irradiation.

In contrast to the uncoated nanotube, the portion of the DWNT with a coating on its surface, however, undergoes transformation towards structure disintegration. As shown in the micrographs (see left arrows in FIG. 3(a)-(c)) the coating material undergoes transformation into some kind of ordered network, and it diffuses along the length of the nanotube from the left towards the right end. The constructive transformation of the coating by the electron beam may be quite useful for mechanical applications involving nanotube based fibers. The electron-beam dose values for the two distinct events of diameter shrinkage and structure disintegration of the DWNT are 5.6×10²⁶ electrons/m² and 3.7×10²⁶ electrons/m² respectively. As can be expected, the dose values for DWNT structure transformations are relatively greater than those recorded for SWNTs. The presence of an additional nested graphene cylindrical structure inside the outer shell of a DWNT affords a distinctly different geometry and leads to a constructive reorganization of the entire DWNT during beam irradiation.

As discussed in connection to FIGS. 2 and 3, a coating on the surface of a carbon nanotube influences its structural stability during electron beam irradiation. Such coverage may bring about a constructive change in the structure of the nanotubes. Such a change is usually expected under situations involving vacuum annealing of SWNTs at substantially higher temperatures. In the following example, such a structural modification is observed, which leads to a constructive evolution of the overall local nanotube structure. In FIG. 4, the micrographs illustrate the image of crossed DWNTs (left) and images of nanotube regions before and after (right) electron beam irradiation at a beam dose rate of ca 5.1×10²³ electrons/m²·sec. At the end of the irradiation process, with a total beam dose of 10.4×10²⁶ electrons/m² the coating on multiple regions (see the boxes I, II and III) of the double wall nanotubes rearranges into new graphene layers on the tube surface. Apparently, the disordered carbon network on the nanotube surface which is assumed to comprise the coating undergoes rearrangement to give rise to a graphene network made of sheets or partial cylindrical structures. The new graphene layers on the exterior of the nanotubes can be seen as dark lines in the high resolution TEM images on the right hand side in FIG. 4.

### Example 4

Electron Beam Irradiation of Peapods

In order to explore the effects of electron irradiation on hybrid materials composed of C₆₀ molecules inside SWNTs, peapods were subjected to electron irradiation at energies of 80 keV and 100 keV. These energies are respectively below and above the threshold energy for ballistic electron irradiation damage of the carbon nanotubes of ˜86 keV, as determined from the prior work. This experiment is also a model of the effect of electron irradiation on the ends of nanotubes, as the structure of a C₆₀ molecule is composed of two hemispherical end caps of a (5,5) carbon nanotube joined together. Two adjacent C₆₀ molecules sterically confined within a SWNT are an appropriate model for two adjacent (5,5) nanotubes, positioned end-to-end, aligned, and separated by the expected van der Waals bonding distance.

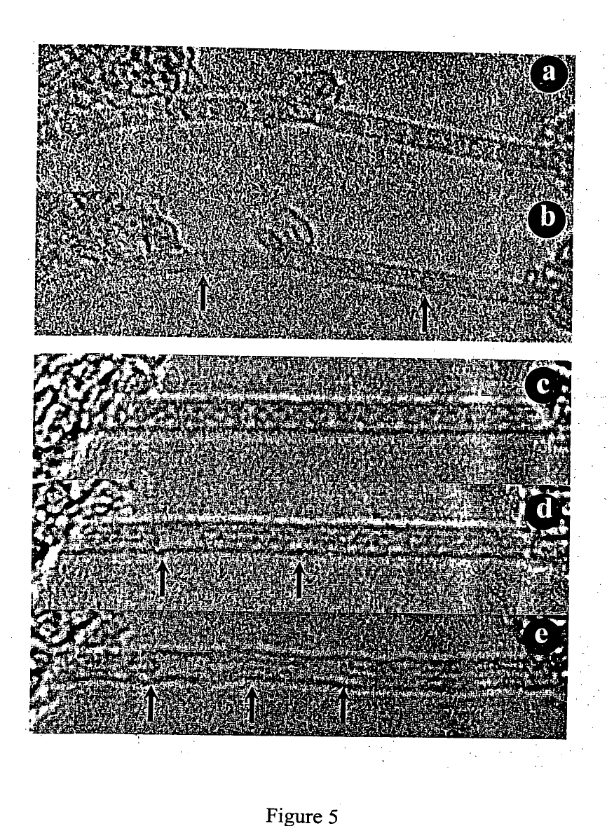

HRTEM micrographs of peapods under electron beam irradiation at 80 keV and 100 keV are shown in FIG. 5(a)-5(b) and 5(c)-5(e) respectively. In both cases, the effect of electron irradiation on the linear chain of C₆₀ molecules is to induce the coalescence of fullerene molecules into carbon nanotubes, contained within the exterior SWNT. Such coalescence of C₆₀ molecules has been reported due to electron beam irradiation at energies of 100 keV and higher, and thermal annealing at temperature of ˜1200° C. After irradiation at 80 keV to an electron dose of ˜2.53×10²⁶ electrons/m² (FIG. 5(b)), coalescence of the interior molecules can be seen (see arrows), while the surrounding SWNT exhibits no modification, consistent with earlier determination of the threshold energy for ballistic irradiation damage. In contrast, after irradiation at 100 keV to a dose of 1.89×10²⁶ electrons/m² (see arrows in FIG. 5(d)), incipient structural damage of the exterior SWNT can be detected, especially at the left hand side of the lower nanotube wall. After an electron dose of 2.83×10²⁶ electrons/M² (see arrows in FIG. 5(e)), extensive damage to the surrounding SWNT is seen. Considering that only carbon atoms along the top and bottom surfaces of the SWNT can be displaced at 100 keV, the disruption of the nanotube is more extensive than what is apparent in the FIG. 5(e).

The results of FIG. 5 confirm the electron-irradiation-induced coalescence of C₆₀ fullerene molecules within the lumen of carbon nanotubes. These results also provide important insight regarding the differences between the responses of nanotube end-caps and side-walls to electron beam irradiation. Due to the different structure (5 member carbon rings), electronic configuration and strain state, nanotube end caps exhibit a higher sensitivity to electron irradiation than nanotube side-walls. This affords the possibility of processing of nanotube assemblies, such as nanotube bundles within neat nanotube fibers or composites, to improve properties through the joining of end-to-end nanotubes, without adversely affecting the nanotube properties through degradation of the side-wall. The electron beam energies at which this beneficial processing effect may be realized are those typically available in commercial electron beam welding equipment. This method provides the possibility of using electron beam irradiation at lower energy to facilitate structure transformation and/or chemical reaction of nanotubes, or molecules within the lumen of nanotubes without losing the structural integrity, and hence the unique electronic structure of the nanotube.

TABLE
The summary of electron beam induced structure transformations
in various nanotubes structures along with the beam
dose rates and dose values.

| | | DOSE RATE | |
|---|---|---|---|
| | STRUCTURE | Electrons/ | DOSE |
| NANOTUBE | TRANSFORMATION | m² · sec | Electrons/m² |
| SWNT | Diameter shrinkage | 3.4 × 10²³ | 4.08 × 10²⁶ |
| a-C/SWNT | Disintegration | 2.8 × 10²³ | 2.52 × 10²⁵ |
| DWNT | Diameter shrinkage | 2.8 × 10²³ | 5.04 × 10²⁶ |
| a-C/DWNT | Disintegration | 2.8 × 10²³ | 8.40 × 10²⁵ |
| SWNT/DWNT | Disintegration | 3.9 × 10²³ | 1.17 × 10²⁶ |
| DWNT/DWNT | Nucleation of new | 5.1 × 10²³ | 10.40 × 10²⁶ |
| | graphene layers | | |

What is claimed is:

1. A method of elongating carbon nanotubes in a carbon nanotube system comprising:
irradiating the system with an energy between about 80 keV to about 90 keV to react the end caps of abutting nanotubes without inducing structural deterioration of the nanotube sidewall.

2. The method of claim 1 wherein at least some of the nanotubes are double walled nanotubes.

3. The method of claim 1 wherein at least some of the nanotubes comprise at least one C₆₀ molecule confined within the lumen of said nanotubes.

4. The method of claim 1 wherein the system is irradiated with ionization radiation.

5. The method of claim 1 wherein the system is irradiated with electron beam radiation, radiant light, or X-rays.

6. The method of claim 1 wherein said radiation has an energy of about 86 keV.

7. The method of claim 1 further comprising conducting the irradiation at a temperature within the range of about 800° C. to about 1600° C.

8. The method of claim 1 further comprising conducting the irradiation at a temperature within the range of about 1000° C. to about 1300° C.

9. A method of butt welding at least two carbon nanotubes in a carbon nanotube system wherein at least one nanotube comprises at least one C₆₀ molecule confined within the lumen of said nanotube, said method comprising:
applying radiation at about 80 keV to about 90 keV to the nanotube system to react the end caps of abutting nanotubes without inducing structural deterioration of the nanotube sidewall.

10. The method of claim 9 wherein at least one nanotube comprises at least one C₆₀ molecule confined within the lumen of said nanotube.

11. The method of claim 9 wherein system is irradiated with ionization radiation.

12. The method of claim 9 wherein system is irradiated with electron beam radiation, radiant light, or X-rays.

13. The method of claim 9 wherein said irradiation is at an energy of about 86 keV.

14. The method of claim 9 further comprising applying a temperature within the range of about 800° C. to about 1600° C.

15. The method of claim 9 further comprising applying a temperature within the range of about 1000° C. to about 1300° C.

16. A method of butt welding at least two carbon nanotubes in a carbon nanotube system comprising irradiating the system at about 86 keV to react the end caps of abutting nanotubes without inducing structural deterioration of the nanotube sidewall.

17. The method of claim 16 wherein at least one nanotube is a double walled nanotube.

18. The method of claim 16 wherein at least one nanotube comprises at least one C₆₀ molecule confined within the lumen of said nanotube.

19. The method of claim 16 wherein the system is irradiated with ionization radiation.

20. The method of claim 16 wherein the system is irradiated with electron beam radiation, radiant light, or X-rays.

21. The method of claim 16 further comprising applying a temperature within the range of about 800° C. to about 1600° C.

22. The method of claim 16 further comprising applying a temperature within the range of about 1000° C. to about 1300° C.

23. A method of elongating carbon nanotubes comprising:
irradiating a collection of carbon nanotubes with an energy between about 80 keV and about 90 keV for a time sufficient to react the end caps of a substantial proportion of abutting nanotubes without inducing structural deterioration of a substantial proportion of the sidewalls of the nanotubes.

24. The method of claim 23 wherein at least some of the nanotubes are double walled nanotubes.

25. The method of claim 23 wherein at least some of the nanotubes comprise at least one C₆₀ molecule confined within the lumen of said nanotubes.

26. The method of claim 23 wherein said nanotubes are irradiated with ionization radiation.

27. The method of claim 23 wherein said nanotubes are irradiated with electron beam radiation, radiant light, or X-rays.

28. The method of claim 23 wherein said irradiation is at an energy of about 86 keV.

29. The method of claim 23 further comprising conducting the irradiation at a temperature within the range of about 800° C. to about 1600° C.

30. The method of claim 23 further comprising conducting the irradiation at a temperature within the range of about 1000° C. to about 1300° C.
